(19) United States
(12) Patent Application Publication
(10) Pub. No.: US 2026/0311593 A1
(43) Pub. Date: Oct. 8, 2026

(54) METHODS AND SYSTEMS FOR IDENTIFYING VEHICLES

(71) Applicant: The Texas A&M University System, College Station, TX (US)

(72) Inventors: Panganamala Ramana Kumar, College Station, TX (US); Jaewon Kim, College Station, TX (US); WooHyun Ko, College Station, TX (US)

(73) Assignee: The Texas A&M University System, College Station, TX (US)

(21) Appl. No.: 19/218,246

(22) Filed: May 24, 2025

Related U.S. Application Data
(60) Provisional application No. 63/651,735, filed on May 24, 2024.

(51) Int. Cl. G08G 1/017; G01S 7/48; G01S 17/06; G08G 1/01; G08G 1/042

(52) U.S. Cl. CPC G08G 1/017; G01S 7/4802; G01S 17/06; G08G 1/0116; G08G 1/0145; G08G 1/042

(57) ABSTRACT

A VIS for identifying one or more vehicles in a spatial domain includes a signal transmitter for transmitting an excitation signal to an address of a target vehicle of a plurality of vehicles present in the spatial domain, a spatial detection system for providing positional information of the plurality of vehicles present in the spatial domain, and a VIU in signal communication with the spatial detection system, the VIU including one or more processors and one or more storage devices coupled to the one or more processors, the one or more storage devices configured to store instructions that, when executed by the one or more processors, configure the one or more processors to identify a positional signature in the positional information received from the spatial detection system, and correlate the address of the target vehicle with the positional signature to identify the target vehicle in the spatial domain.

### CROSS-REFERENCE TO RELATED APPLICATIONS

This application claims benefit of U.S. provisional patent application Ser. No. 63/651,735 filed May 24, 2024, and entitled “Method and Systems for Identifying Vehicles,” which is hereby incorporated herein by reference in its entirety for all purposes.

### STATEMENT REGARDING FEDERALLY SPONSORED RESEARCH OR DEVELOPMENT

This invention was made with government support under W911NF2120064 awarded by the Army Research Office of the department of defense. The government has certain rights in the invention.

### BACKGROUND

Various communication systems facilitate wireless communication between a communication unit and a plurality of different vehicles occupying a spatial domain. Particularly, the communication unit may wirelessly transmit a signal including an address corresponding to an address of one of the different vehicles occupying the spatial domain. In this manner, the vehicle having the address matching that contained in the transmitted signal may receive the signal. Moreover, given that the signal may propagate in multiple directions (e.g., omnidirectionally) from the communication unit, the communication unit may communicate the signal to the vehicle having the corresponding address without knowing the position of the particular vehicle having the matching address. As an example, some smart traffic management systems include a communication unit in the form of a roadside unit (RSU) in wireless communication with a plurality of vehicles (e.g., passenger vehicles) travelling along one or more roadways within a spatial domain.

### SUMMARY

An embodiment of a vehicle identification system (VIS) for identifying one or more vehicles in a spatial domain comprises a signal transmitter for transmitting an excitation signal to an address of a target vehicle of a plurality of vehicles present in the spatial domain, a spatial detection system for providing positional information of the plurality of vehicles present in the spatial domain, and a vehicle identification unit (VIU) in signal communication with the spatial detection system, the VIU comprising one or more processors and one or more storage devices coupled to the one or more processors, the one or more storage devices configured to store instructions that, when executed by the one or more processors, configure the one or more processors to identify a positional signature in the positional information received from the spatial detection system, and correlate the address of the target vehicle with the positional signature to identify the target vehicle in the spatial domain. In some embodiments, the excitation signal comprises a random signal. In some embodiments, the excitation signal is superimposed onto a control input that is applied to the target vehicle. In certain embodiments, the target vehicle is configured to produce the positional signature in response to receiving the excitation signal. In certain embodiments, the plurality of vehicles correspond to a plurality of independent domains. In some embodiments, the spatial domain comprises three-dimensional (3D) physical space. In some embodiments, the spatial detection system comprises an active spatial detection system comprising a signal generator and a signal receiver configured to receive spatial signals generated by the signal generator and that have interacted with at least some of the plurality of vehicles. In certain embodiments, the spatial signals generated by the signal generator comprise electromagnetic energy. In certain embodiments, the spatial detection system comprises a passive spatial detection system. In some embodiments, the spatial detection system is configured to collect at least one of electromagnetic energy or acoustic energy. In some embodiments, the signal transmitter is configured to transmit a plurality of the excitation signals that are different from one another to a plurality of addresses of a plurality of target vehicles present in the spatial domain, and the instructions, when executed by the one or more processors of the VIU, configure the one or more processors to identify a plurality of positional signatures that are different from one another in the positional information received from the spatial detection system, and correlate the plurality of addresses of the target vehicles with the plurality of positional signatures to independently identify each of the plurality of target vehicles in the spatial domain.

An embodiment of a method for identifying one or more vehicles in a spatial domain comprises (a) transmitting an excitation signal to an address of a target vehicle of a plurality of vehicles present in the spatial domain, (b) receiving positional information from a spatial detection system associated with a plurality of vehicles present in a spatial domain, (c) identifying a positional signature in the positional information received from the spatial detection system, the positional signature associated with the excitation signal, and (d) correlating the address of the target vehicle with the positional signature to identify the target vehicle in the spatial domain. In certain embodiments, the excitation signal comprises a random signal. In certain embodiments, the method comprises (e) superimposing the excitation signal onto a control input applied to the target vehicle to cause the target vehicle to produce the positional signature. In some embodiments, the method comprises (e) capturing by the spatial detection system at least one of electromagnetic energy or acoustic energy propagating through the spatial domain to determine the positional information. In some embodiments, the method comprises (e) generating a spatial signal by the spatial detection system that propagates through the spatial domain, and (f) capturing the spatial signal by the spatial detection system in response to the spatial signal interacting with at least one of the plurality of vehicles. In certain embodiments, the spatial domain comprises 3D physical space.

An embodiment of a system comprises one or more processors, and one or more storage devices coupled to the one or more processors, the one or more storage devices configured to store instructions that, when executed by the one or more processors, configure the one or more processors to (a) receive positional information from a spatial detection system associated with a plurality of vehicles present in a spatial domain, (b) identify a positional signature in the positional information received from the spatial detection system, the positional signature associated with an excitation signal transmitted to an address of a target vehicle of the plurality of vehicles, and (c) correlate the address of the target vehicle with the positional signature to identify the target vehicle in the spatial domain. In certain embodiments, the excitation signal comprises a random signal. In some embodiments, the excitation signal is superimposed onto a control input that is applied to the target vehicle.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a schematic representation of an exemplary VIS in accordance with principles disclosed herein;

FIGS. 2-5 are graphs illustrating positional information for a vehicle identifiable by a VIS in accordance with principles disclosed herein;

FIG. 6 is a schematic representation of another exemplary VIS in accordance with principles disclosed herein;

FIG. 7 is a schematic representation of yet another exemplary VIS in accordance with principles disclosed herein;

FIG. 8 is a schematic representation of embodiment of a method for identifying vehicles in accordance with principles disclosed herein; and

FIG. 9 is a block diagram of an embodiment of a computer system in accordance with principles disclosed herein.

### DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Further, as used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, communication systems, including smart traffic management systems and the like, facilitate wireless communication between a communication unit and a plurality of different vehicles occupying a spatial domain. In some instances, the communication unit may include one more sensors such as cameras and the like which may be used to observe the various vehicles occupying the spatial domain. However, while the cameras or other sensors may observe the vehicles occupying the spatial domain, the communication unit may not be able to determine the identity of different vehicles observed by the sensors thereof. In other words, the communication unit may be unable to match or determine a particular address (e.g., a network address) of a target vehicle observed by the one or more sensors of the communication system.

In at least some applications, it may be desirable to identify the addresses of one or more target vehicles observed by the one or more sensors of the communication unit in order to communicate directly with the one or more target vehicles. For example, it may be necessary for an RSU to send specific information to one or more particular vehicles present in its visual field over the underlying network in order to avoid its collision with another vehicle. While the RSU can visually identify the target vehicle within its camera's field of view through visual object detection, the RSU of conventional systems lacks the necessary information, such as the network address (e.g., internet protocol (IP) address or media access control (MAC) address) associated with the identified target vehicle to directly communicate with the target vehicle. Moreover, in urgent situations such as potential accidents or collisions, the information transmitted by the RSU may need to be directed immediately towards a target vehicle within the visual field of the RSU. Thus, in order to communicate with the visually identified vehicle, the RSU may need to identify the network address that corresponds to the visually identified vehicle. Once this determination is made, the RSU can then share vehicle-specific information with a target vehicle.

In some instances, the vehicles within the spatial domain may be provided with unique identifiers observable by the one or more sensors of the communication unit and which are known to the communication unit to permit the communication unit to identify the vehicles observed by the one or more sensors thereof. However, such identifiers are not a practical solution in applications where it is not feasible to provide such identifiers to the vehicles and/or the communication unit (so the communication unit can corroborate the identifier observed on a given vehicle) beforehand.

Accordingly, embodiments of vehicle identification systems (VIS) are disclosed herein that may be used to facilitate communication with one or more target vehicles occupying a spatial domain occupied by a group of vehicles. Such VIS may be useful in a variety of applications including, for example, smart traffic management systems. In this problem, embodiments of VIS disclosed herein address the problem of identifying one or more target vehicles in a spatial domain (e.g., a multi-dimensional space) occupied by additional vehicles, when wireless or other communication is available with the vehicles which can be observed with sensors, but it is not known which vehicle under observation has which wireless. address. Without such a VIS, it may be impossible to correlate addresses (e.g., wireless network addresses from a list of network addresses corresponding to each vehicle present in the spatial domain including vehicles other than the one or more target vehicles) with the one or more target vehicles. Particularly, as described above, a list of addresses alone may not provide sufficient information for identifying the specific network addresses correlated with the one or more target vehicles occupying the spatial domain given that such network addresses may not provide positional information for the different vehicles occupying the spatial domain. In other words, a VIS will bridge this gap permitting users to identify the network addresses of one or more particular vehicles identified or target within a spatial domain occupied by a plurality of separate vehicles.

Embodiments of VIS disclosed herein include methods and systems for identifying one or more target vehicles in a spatial domain. As used herein, the term “spatial domain” is defined as any space having one or more different dimensions occupiable by a plurality of different vehicles. For instance, the spatial domain may be a three-dimensional (3D) physical space or a virtual space that may have fewer or more than three separate dimensions. Correspondingly, the vehicles identifiable by embodiments of VIS disclosed herein may include a variety of physical vehicles including ground vehicles, air vehicles, surface water vehicles, space vehicles, and underwater vehicles. The number of vehicles occupying the spatial domain may vary substantially depending on the given application, and vehicles of various types (e.g., ground vehicles, air vehicles, underwater vehicles) and domains may be identifiable by the same VIS.

Embodiments of VIS disclosed herein generally include a vehicle identification unit (VIU) and one or more spatial detection systems in signal communication with the VIU. The spatial detection system may identify one or more target vehicles within a spatial domain. Particularly, as used herein, the term “spatial detection system” is defined as a system that actively or passively captures spatial signals from which positional information of objects distributed in a spatial domain may be determined. Spatial signals may comprise signals propagatable through a spatial domain and which interact (e.g., reflect off of) with objects present in the spatial domain.

Such spatial detection systems may map the spatial domain by sampling spatial signals in the form of energy propagating through the spatial domain that interacts with objects present therein including one or more target vehicles. For example, spatial detection systems may include one or more cameras that capture spatial signals in the form of visible light from the spatial domain. The spatial detection system may capture spatial signals in the form of other kinds of energy including acoustic energy, vibrational energy, magnetic energy (e.g., a static magnetic field), and electromagnetic energy besides visible light including, for instance, radio waves, infrared light, and the like.

Moreover, the spatial detection system may be passive or active in nature. With passive spatial detection systems, the spatial signals captured by the spatial detection system may originate from a source other than the spatial detection system itself such as a natural (e.g., the sun) or artificial source. An exemplary passive spatial detection system may include one or more cameras gathering light from a physical spatial domain. Alternatively, active spatial detection systems include spatial detection systems having a signal generator that provides the spatial signals ultimately captured by the spatial detection system to identify one or more target vehicles such as, for example, Radar and Sonar systems.

The VIU of embodiments of VIS disclosed herein may receive or determine positional information of vehicles present in the spatial domain based on information (e.g., positional information, spatial signals) provided by the spatial detection system. Particularly, the VIU may identify or detect positional signatures present in the positional information associated with an excitation signal transmitted from a signal transmitter of the VIS to target vehicles present in the spatial domain. The excitation signal may, for example, comprise signal that is superimposed onto a control input that is applied to the vehicles having the selected addresses whereby the vehicles produce or exhibit the positional signature from which their position may be identified by the VIU. The excitation signal may thus alter the position, speed, heading, and/or acceleration of the vehicle in an identifiable manner so that it can be correlated or matched with the positional signature observed by the spatial detection system.

In some embodiments, the excitation signal may comprise a non-reproducible random signal such as a random modulation of one or more control inputs of a given vehicle over a predefined period of time that results in a change in the behavior of the vehicle (e.g., in its position, speed, heading, and/or acceleration) that corresponds to or defines the positional signature. In certain embodiments, the excitation signal may instead comprise a predefined signal defining one or more control inputs (or alterations thereof). The excitation signal may be relatively small in magnitude so as to be executable by the vehicle and unobtrusive to an operator thereof. The excitation signal may be known by the VIU at least following its generation or transmission such that the VIU may match the excitation signal with the positional signature. In certain embodiments, the VIU may have knowledge (e.g., dynamic models) of how the vehicles present in the spatial domain react in response to receiving different control inputs in order to correlate a given excitation signal with a positional signature exhibited by a vehicle that receives the excitation signal.

The specific addresses of the vehicles in the visual field of an intelligent vehicle identification unit (VIU), for example, an intelligent road-side unit (RSU) may be identified by associating the movement of the vehicles with an excitation signal (dynamic watermark) sent to or from a particular network address. The methods and systems disclosed herein include an VIU comprising a spatial detection system configured to detect and monitor vehicles in its visual field, and a transmitter configured to transmit an excitation signal wirelessly to vehicles in the visual field of the VIU, whereby the vehicles superimpose their excitation signal on the command control of the vehicles. The methods and systems disclosed herein include an I-VIU configured to analyze the movement of each vehicle and associate the movement of each vehicle to the particular excitation signal to determine which vehicle has adjusted its movement according to the excitation signal.

Embodiments described herein, include using a dynamic watermarking-based method for mapping vehicles in the visual or other sensor field of an VIU to their network addresses. For example, the VIU may generate a random excitation signal or dynamic watermark, which is addressed to a vehicle with a particular network address, and transmitted over the underlying wireless communication network. The watermark may include a message packet instructing the vehicle to dither its movement in a random way or according to the excitation signal. The vehicle may superimpose the dither on its command control inputs (e.g., via an actuator of the vehicle controlling a steering wheel, throttle, brake etc. ,) and thereby introduce minor perturbations to its movement. For example, the control input may steer the vehicle in a particular direction, and increase or decrease the speed of the vehicle according to the instructions of the watermark. The VIU, monitoring all the vehicles within its visual (or other sensor) field, then analyzes the movements of all the vehicles to determine which vehicle's movement is appropriately related to the watermark, and thereby identify the network address matching or associated with the vehicle whose movement is dithered according to the watermark. In this manner, any vehicle whose movement is not appropriately related to the watermark, is not associated with or linked to that network address.

In an embodiment, a system for identifying a vehicle comprises a VIU configured to receive message packets comprising network addresses from a plurality of vehicles, and generate an excitation signal, and a transmitter coupled to the VIU and configured to transmit the excitation signal to the network addresses of vehicles, where the VIU comprises a spatial detection system configured to detect an image and monitor a movement of each of the vehicles; and wherein the VIU is configured to associate a target vehicle whose movements are appropriately related to the excitation signal with the network address corresponding to the target vehicle using the excitation signal. As used herein, a “target vehicle” refers to a particular vehicle within a network of vehicles, that has been identified or selected by a VIS for the purpose of communication.

In some embodiments, a system for identifying a vehicle comprises a plurality of vehicles; and an VIU unit comprising a spatial detection system configured to detect and monitor a movement of each of the vehicles; and a memory configured to store a predefined signal, where the VIU is configured to associate a target vehicle with a network address using the predefined signal.

In some embodiments, a method for identifying a vehicle comprises receiving, by a VIU, a message packet comprising network addresses from a plurality of vehicles, wherein the VIU comprises a spatial detection system configured to detect and monitor a movement of each of the vehicles, a transmitter and a signal generator; transmitting, by the VIU, an excitation signal to vehicles in the network; and associating, by the VIU, a target vehicle movement that is appropriately related to the excitation signal with a network address corresponding to the target vehicle using the excitation signal.

In some embodiments, the VIU may comprise a RSU, the mobile vehicles under its observation are cars, the cars are observed by a camera of the RSU, and the RSU communicates wirelessly with the cars using their MAC addresses. The RSU transmits a signal including an “excitation signature” to a particular MAC address. The vehicle with this MAC address that receives this excitation signature applies this signature to its actuators, such that the vehicle moves in a way appropriately related to the excitation signature. The camera of the RSU then examines the movements of the vehicles under its camera observation, and determines which of its observed vehicles is moving in a way appropriately related to the transmitted excitation signature. Thereby it determines which of the cars under its camera observation corresponds to the MAC address to which the excitation signature was sent. It therefore associates that car in its camera field with this particular MAC address.

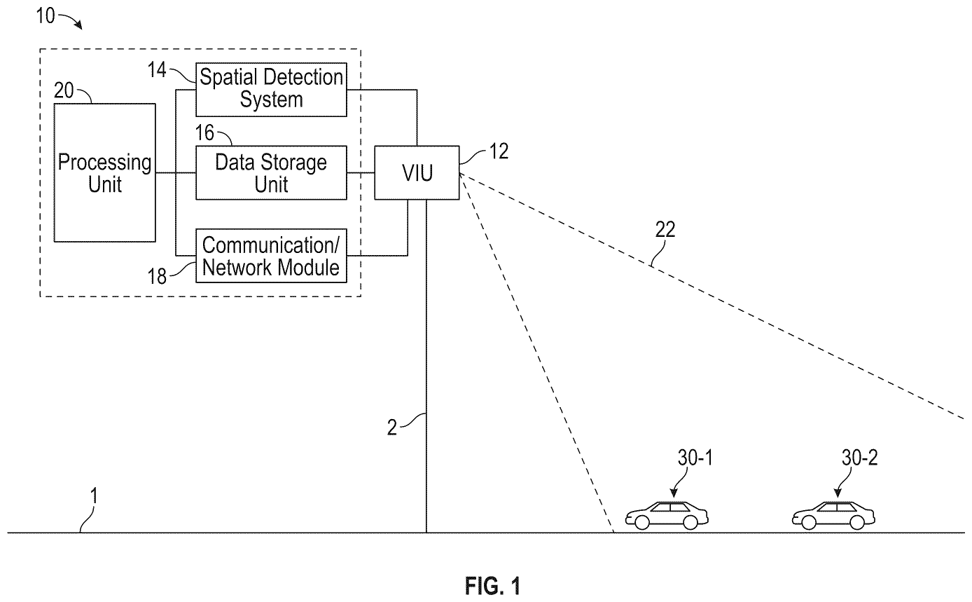

Referring to FIG. 1, an embodiment of an exemplary VIS 10 in accordance with principles disclosed herein is shown. VIS 10 may be used to identify and communicate with one or more vehicles in a spatial domain.

In this exemplary embodiment, VIS 10 is used to monitor vehicles along a roadway. As will be discussed further herein, the operation of VIS 10 is at least partially if not fully automated in monitoring and/or identifying vehicles for purposes of, for example, tolling, traffic enforcement, access control, or fleet management. In this exemplary embodiment, VIS 10 generally includes a vehicle identification unit (VIU) 12 for identifying vehicles 30 (shown as vehicles 30-1 and 30-2 in FIG. 1) in a spatial domain 22. In some embodiments, the VIU 12 may be mounted on a land surface (e.g., along a roadway, at an intersection, or highway infrastructure) to enable wireless/wired communication between vehicles and roadway infrastructure. For example, VIU 12 may be configured to enable infrastructure-to-vehicle (I2V) and vehicle-to-everything (V2X) communication in intelligent transportation systems. In this embodiment, VIU 12 serves merely as an example of a vehicle identification unit used on land, as will be discussed further herein. Thus, VIU 12 may vary from that shown in FIG. 1 in other embodiments. For instance, VIS 10 may be configured to identify vehicles in other domains, for example, an air domain, a space domain, a surface water domain, an underwater domain.

VIU 12 is coupled to a support stand 2 mounted on a roadway 1 and configured to monitor (i.e., detect, identify, and communicate) with vehicles within the spatial domain 22 which comprises 3D space in this embodiment. Support stand 2 may include traffic poles, mast arms, or other structure for providing support to VIU 12. In this exemplary embodiment, VIU 12 generally includes a power supply unit (not shown in FIG. 1), for example, alternating current (AC) power with optional battery backup or solar panel; a spatial detection system 14 that captures positional information of the vehicles 30-1 and 30-2 present in the spatial domain 5. Such positional information may be captured in the form of images which indicate speed, direction, other identifying features, or condition of vehicles 30-1 and 30-2 (e.g., self-driving or driverless vehicles) within a spatial domain 22. Particularly, the positional information may be determined by the VIU 12 from spatial signals captured by the spatial detection system 14. The spatial signals may comprise electromagnetic signals and/or other signals (e.g., acoustic signals) propagatable through the spatial domain 22 and which may interact with (e.g., reflect off of) the vehicles 30-1 and 30-2 whereby such spatial signals may be captured by the spatial detection system 14. The VIU 12 may determine positional information of the vehicles 30-1 and 30-2 present in the spatial domain 22 based off the captured spatial signals. For instance, the spatial signals may describe or characterize a relative distance or position of vehicles 30-1 and 30-2 and the VIU 12 from which relative positional information of the vehicles 30-1 and 30-2 may be determined. By monitoring the positional information of vehicles 30-1 and 30-2 over time, changes in the position of vehicles 30-1 and 30-2 (e.g., relative VIU 12) may be monitored to determine speed, heading, acceleration, and the like, of vehicles 30-1 and 30-2 over time.

VIU 12 additionally includes, in this exemplary embodiment a data storage unit 16 storing instructions for identifying, authenticating and communicating with the one or more vehicles 30-1 and 30-2, a communication and network module 18 for exchanging information with the one or more vehicles 30-1 and 30-2 or remote systems, such as traffic management centers, automated enforcement systems, and other infrastructure; and a processing unit 20 operatively coupled to spatial detection system 14, data storage unit 16, and communication and network module 18. These components may be at least partially received within VIU 12 and/or mounted external to the VIU 12. The VIU 12 may take various shapes and may comprise various components depending upon the given application. The power supply unit of VIU 12 provides power (e.g., electrical power) to the different components of VIU 12 including, for example, communication and network module 18, and spatial detection system 14. The physical configuration, power storage capacity, and other attributes of the power supply unit may vary depending on the given application. For instance, in some embodiments, the power supply comprises one or more electrical batteries such as lithium batteries and the like. However, the power supply unit may comprise power sources other than electrical batteries in other embodiments.

Communication and network module 18 may include a transmitter supporting wireless communication protocols, such as dedicated short-range communication (DSRC), cellular-V 2X, or 5G, and one or more antennas for signal transmission and reception. The data acquired by spatial detection system 14 is transmitted via communication and network module 18 to processing unit 20, which may be located locally within VIU 12 or remotely located in a control center or cloud based infrastructure coupled to VIU 12. The processing unit 20 analyzes the acquired data and extracts relevant identification information associated with one or more vehicles 30-1 and 30-2 in the spatial domain 22. Using VIU 12, VIS 10 is able to identify a vehicle's identity and status within its surrounding. In some embodiments, the communication and network module 18 allows bi-directional flow of data or information between VIU 12 and the one or more vehicles 30-1 and 30-2. This enables real-time operational responses such as alerts, access control decisions, or coordination with other infrastructure to improve safety, efficiency, as well as law enforcement and traffic flow management.

As the vehicles 30-1 and 30-2 enter the VIU's vicinity (i.e., spatial domain 22), the communication and network module 18 transmits a message packet containing an excitation signal to a selected address (e.g., a network address and the like) of one of the vehicles 30-1 and 30-2. The vehicle 30-1 and/or 30-2 receiving the excitation signal may produce or exhibit a positional signature in response to receiving the excitation signal that may be included in the positional information collected by the VIU 12. The VIU 12, in identifying or spotting a given vehicle 30 exhibiting the positional signature associated with the excitation signal, may thereby correlate the address that received the excitation signal with the vehicle identified by the spatial detection system 14 within the spatial domain 22. In other words, the VIU 12 may correlate or identify a position of the specific vehicle 30-1 and/or 30-2 within the spatial domain 22 having the address that received the excitation signal.

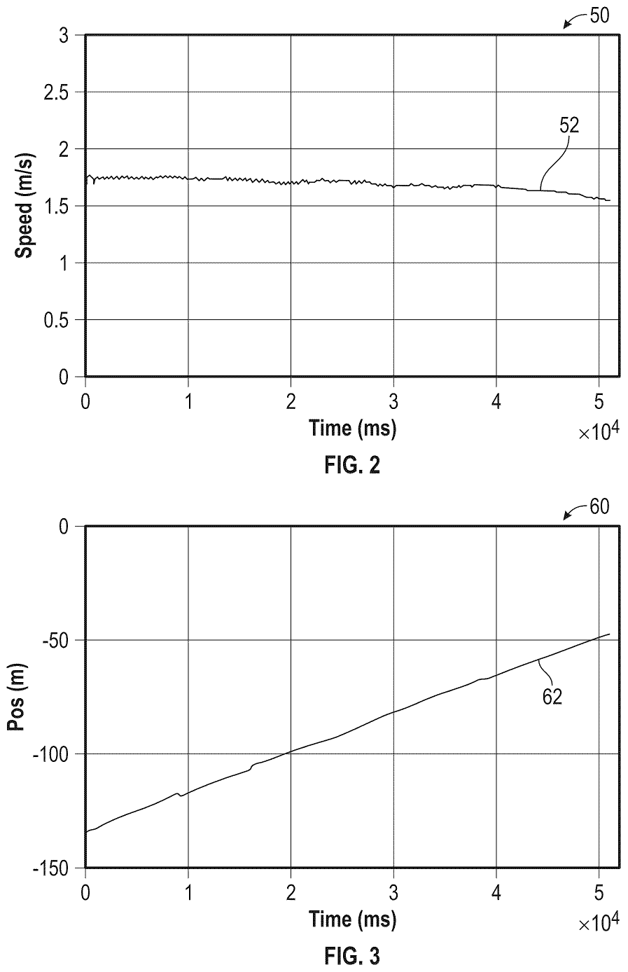

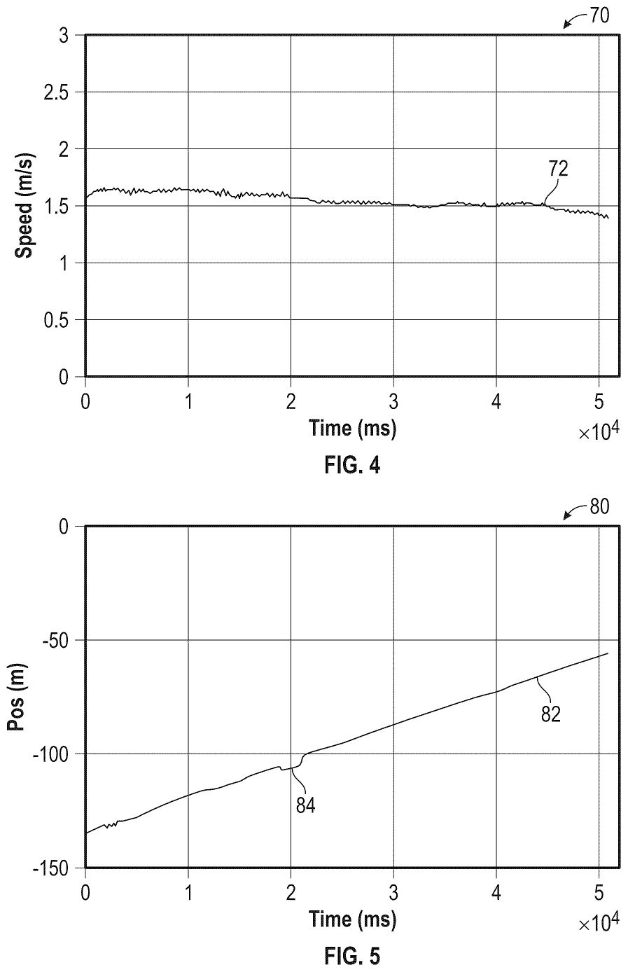

As an example, and referring to FIGS. 2-5, exemplary graphs 50, 60, 70, and 80, respectively, are shown illustrating positional information for a vehicle identifiable by a VIS such as VIS 10 shown in FIG. 1. Particularly, graphs 50 (depicting speed versus time) and 60 (depicting position versus time) illustrate speed 52 and position 62, respectively, for a vehicle moving through a spatial domain. The vehicle travels in accordance with command inputs that may be received by a human operator thereof or autonomously via an autonomous control system. The control inputs resulting in speed 52 and position 62 for the vehicle do not include an excitation signal. Graphs 70 and 80 also illustrate speed 72 and position 82, respectively, for the same vehicle moving through the spatial domain being operated in the same manner as that captured in graphs 50 and 60. However, unlike graphs 50 and 60, an excitation signal has been applied to the vehicle in graphs 50 and 60 resulting in the speed 72 and position 82 varying from the speed 52 and position 62 shown in graphs 50 and 60 at certain points in time. Particularly, an exemplary positional signature 84 is shown in graph 80 as a legible deviation from the position 62 of the vehicle.

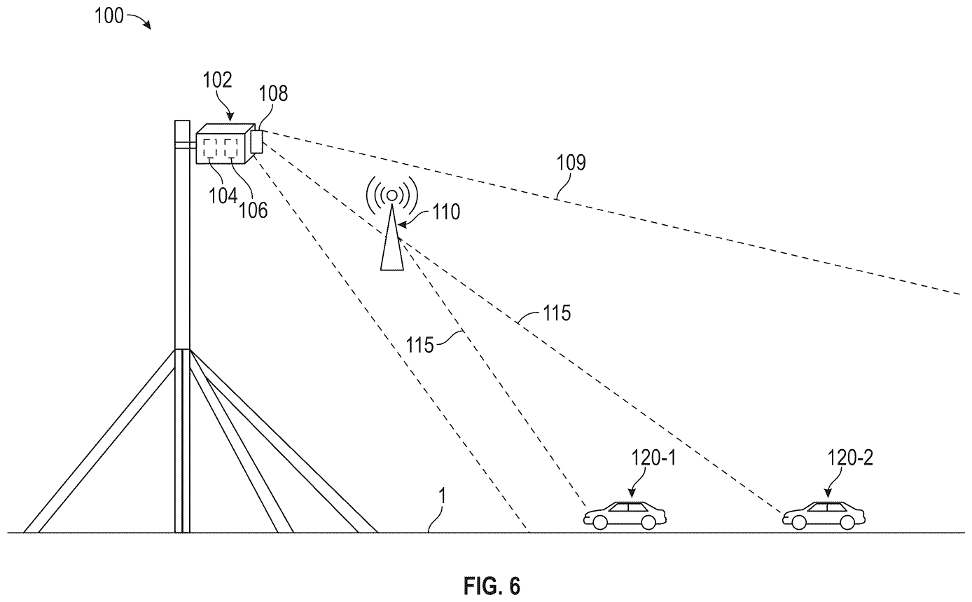

Referring to FIG. 6, an embodiment of another exemplary VIS 100 in accordance with principles disclosed herein is shown. VIS 100 comprises features in common or may be configured similarly as VIS 10, and like components are labeled similarly. In this exemplary embodiment, VIU-102 includes a transceiver 104 configured to receive message packets comprising network addresses of a plurality of vehicles 120 (shown as vehicles 120-1 and 120-2 in FIG. 6) in a network, a processing unit (e.g., processing unit 20 of FIG. 1) including a signal generator 106 for generating an excitation signal imposable on a command control of each of the plurality of vehicles 120-1 and 120-2, and a spatial detection system 108 having a visual field 109 extending from the spatial detection system 108 to roadway 1. More particularly, VIU 102 is configured to identify a target vehicle among the plurality of vehicles 120-1 and 120-2 within the visual field 109, by generating a random, pseudo-random or specific excitation signal, transmitting the excitation signal to each of the plurality of vehicles 120-1 and 120-2 via transmitter 110, and monitoring movement of each of the plurality of vehicles 120-1 and 120-2 to identify the target vehicle. In this manner, VIU 102 is able to communicate with and send the information in the message packet to the target vehicle in the visual field 109 once identified.

The transceiver 104 is configured to facilitate real-time two-way or bi-directional wireless communication and data exchange between VIU 102 and external communication devices and infrastructure or nearby vehicles. Its primary function is to transmit and receive data/message packets, allowing the VIU 102 to send messages such as traffic alerts, speed advisories, or safety instructions to one or more of the plurality of vehicles 120-1 and 120-2, while also receiving information like status updates. In some embodiments, transceiver 104 comprises an antenna or antenna array configured to communicate electromagnetically with external communication devices. However, the configuration of transceiver 104 may vary in other embodiments. For instance, in other embodiments, transceiver 104 may manage MAC functions, coordinating how multiple devices share the wireless channel and preventing signal collisions.

The message packet may include the actual information or data, and control information that allows VIU 102 to properly route and deliver the actual information or data to the target vehicle. The control information may comprise metadata such as source and destination identifiers, message type, sequence numbers, timestamps, and encryption or authentication details to ensure the integrity and security of the transmission. In this embodiment, the message packet received by VIU 102 comprise network addresses (e.g., internet protocol (IP) address or media access control (MAC) associated with each of the plurality of vehicles 120-1 and 120-2 in the network including the target vehicle) to directly communicate with the target vehicle. However, the configuration of the message packets may vary in other embodiments. For instance, in other embodiments, the control information may include a protocol identifier.

The spatial detection system 108 may include one or more cameras and integrated sensors including radar for detecting the speed and distance of vehicles under various conditions, LiDAR for generating a 3D map of the surrounding area, ultrasonic sensors for vehicle detection, and other environmental detectors. The camera is configured to capture a series of images of the plurality of vehicles 120-1 and 120-2 and may include visible light and infrared types. In some embodiments, the camera may employ computer vision algorithms and machine learning models to identify and classify objects and interpret traffic scenarios and may comprise a zoom lens permitting the camera to focus at different distances from the VIU 102. Additionally, the camera may be coupled to a camera mount for controlling the orientation of the lens. In this manner, the orientation of the lens of the camera may be controlled independently of the VIU 102. The spatial signal (e.g., camera and/or sensor data) may be processes locally within the VIU 102 or sent to edge servers or cloud platforms for further analysis.

The signal generator functions as a controlled source of electrical or electromagnetic energy configured to trigger a specific response (e.g., a dither or movements) from the target vehicle. The signal generator may be implemented as hardware, software, or a combination of both depending on the application. In this embodiment, signal generator 106 is implemented in the firmware within the VIU's processing unit and is configured to produce excitation signals with defined characteristics such as frequency, amplitude duration, and shape (sinusoidal, pulse, or modulated bursts). The signal generator 106 is configured to generate an excitation signal carrying a dynamic watermark, which is transmitted wirelessly to each of the plurality of vehicles 120-1 and 120-2 within the visual field 109. The signal generator may be configured to generate, for example, a random, pseudo-random or a specific excitation signal for a predefined duration depending on the application.

Once generated, the excitation signal may be modulated into a transmittable format. In this embodiment, the transmitter 110 amplifies and transmits the excitation signal wirelessly through one or more antennas, ensuring appropriate power levels and frequencies to reach individual vehicles within visual field 109. The transmitted excitation signal is a dynamic watermark configured to trigger a specific response from the target vehicle's command control (e.g., via an actuator of the vehicle controlling a steering wheel, throttle, brake etc. ,). The response may include minor perturbations to the target vehicles'movements (e.g., speed adjustment), lane change, braking or acceleration prompts and so on.

As the plurality of vehicles 120-1 and 120-2 enter the VIU 102's vicinity, the VIU 102 receives a message packet comprising actual information intended for a target vehicle within the visual field 109 of spatial detection system 108 along with the IP/MAC addresses for a plurality of vehicles in a network. The VIU-102 processes the information and generates an excitation signal including a dynamic watermark for identifying the target vehicle for which the actual information in the message packet is intended. The VIU 102 may transmit the excitation signal to a first IP/MAC address via transmitter 110 monitoring the response of the vehicles via spatial detection system 108, and then to subsequent IP/MAC addresses monitoring the responses until a response appropriately correlated is observed via the spatial detection system 108. In this manner, the VIU 102 is able to identify the target vehicle based on the response trigger by and correlated with the excitation signal.

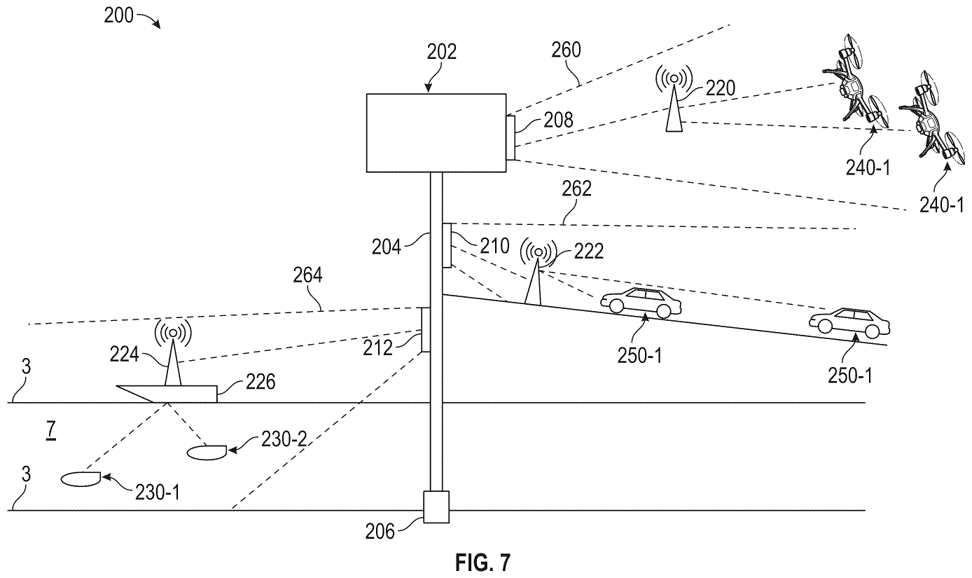

Referring to FIG. 7, an embodiment of another exemplary VIS in accordance with principles disclosed herein is shown. VIS 200 comprises features in common or may be configured similarly as VIS 100, and like components are labeled similarly. Particularly, VIS 200 comprises an air transmitter 220, a land based transmitter 222, and a marine transmitter 224 that is supported on a vessel 226 above a water surface 3, and a VIU 202 coupled to and supported by a support structure 204 anchored to a foundation 206 coupled to a seabed 5 and extending through a water column 7 between the foundation 206 and support structure 204. In this exemplary embodiment, VIU 202 includes an air-based spatial detection system 208 for identifying air vehicles 240 (shown as air vehicles 240-1 and 240-2 in FIG. 7) (e.g., unmanned aerial vehicles (UAV), drones and aircraft) interacting with VIU 202; a land-based sensor unit 210 for identifying land vehicles 250 (shown as land vehicles 250-1 and 250-2 in FIG. 7) (e.g., unmanned or driverless vehicles), which may be similar to spatial detection system 108 of FIG. 6, and a water-based sensor unit 212 for identifying marine and underwater vehicles 230 (shown as underwater vehicles 230-1 and 230-2 in FIG. 7) (e.g., autonomous underwater vehicles (AUV), vessels) and water obstacles.

As previously described, VIU 202 may receive a message packet comprising actual information intended for a target vehicle (e.g., land vehicles 250-1 and 250-2, air vehicles 240-1 and 240-2, or underwater vehicles 230-1 and 230-2) within any one of the visual fields (i.e., air visual field 260 of spatial detection system 208, land visual field 262 of sensor 210, or water visual field 264 of sensor 212) along with the IP/MAC addresses for a plurality of vehicles in a network. The VIU 202 processes the information and generates an excitation signal including a dynamic watermark for identifying the target vehicle within the specific environment (air, land, or water) for which the actual information in the message packet is intended. For example, VIU 202 may identify the target vehicle as an air vehicle, a land vehicle, or a water vehicle based on the message packet and generate an excitation signal. The VIU 202 transmits the excitation signal to a first IP/MAC address via the appropriate transmitter (i.e., transmitter 220, transmitter 222, or transmitter 224) monitoring the response of the vehicles via the sensor unit corresponding to the environment (e.g., air-based spatial detection system 208, land-based sensor 210, or water-based sensor 212) and then to subsequent IP/MAC addresses monitoring the responses until a response appropriately correlated with the excitation signal is observed via the sensor. In this manner, the VIU 202 is able to identify the target vehicle based on the response triggered by and correlated with the excitation signal.

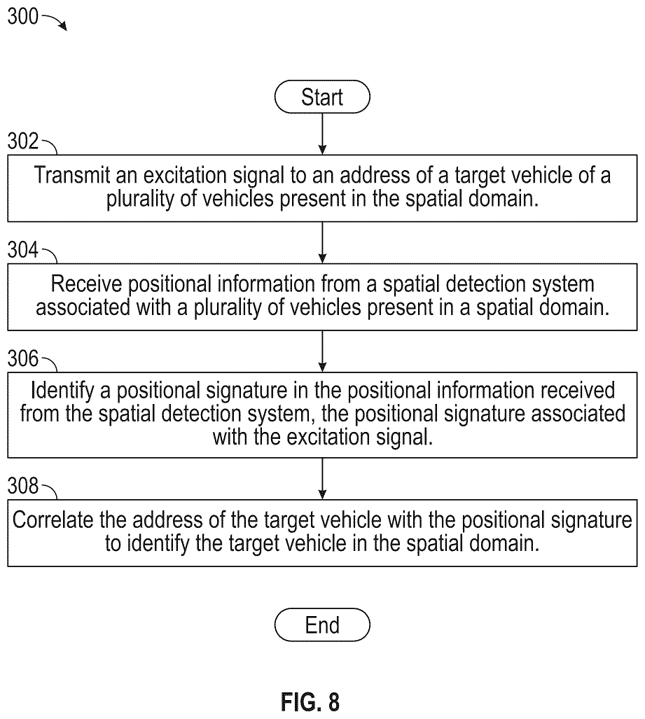

Referring to FIG. 8 an exemplary method 300 for identifying one or more vehicles in a spatial domain is shown. Initially, at block 302, method 300 comprises transmitting an excitation signal to an address of a target vehicle of a plurality of vehicles present in the spatial domain. At block 304, method 300 comprises receiving positional information from a spatial detection system associated with a plurality of vehicles present in a spatial domain. At block 306, method 300 comprises identifying a positional signature in the positional information received from the spatial detection system, the positional signature associated with the excitation signal. At block 308, method 300 comprises correlating the address of the target vehicle with the positional signature to identify the target vehicle in the spatial domain.

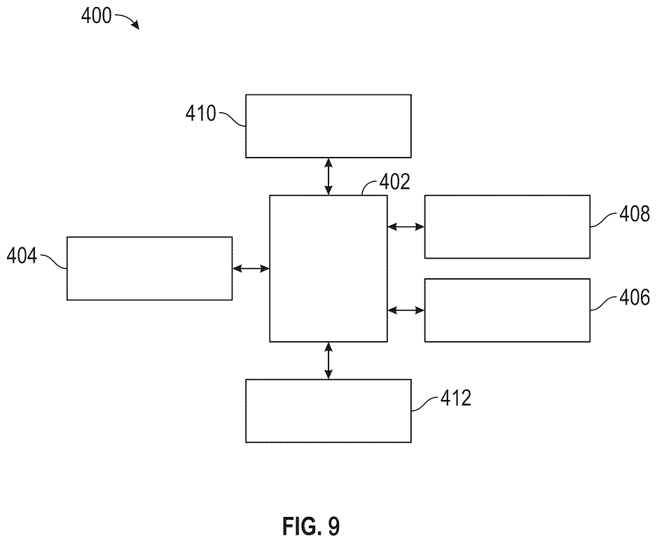

Referring to FIG. 9, a block diagram of an embodiment of an exemplary computer system 400 in accordance with principles disclosed herein is shown. For example, the VIU 12 shown in FIG. 1 may comprise the computer system 400 or may incorporate at least some of the features of computer system 400. The computer system 400 of FIG. 1 includes a processor 402 (which may be referred to as a central processor unit or CPU) that is in communication with memory devices including secondary storage 404, read only memory (ROM) 406, random access memory (RAM) 408, input/output (I/O) devices 410, and network connectivity devices 412. The processor 402 may be implemented as one or more CPU chips. It is understood that by programming and/or loading executable instructions onto the computer system 400, at least one of the CPU 402, the RAM 408, and the ROM 406 are changed, transforming the computer system 400 in part into a particular machine or apparatus having the novel functionality taught by the present disclosure.

Additionally, after the system 400 is turned on or booted, the CPU 402 may execute a computer program or application. For example, the CPU 402 may execute software or firmware stored in the ROM 406 or stored in the RAM 408. In some cases, on boot and/or when the application is initiated, the CPU 402 may copy the application or portions of the application from the secondary storage 404 to the RAM 408 or to memory space within the CPU 402 itself, and the CPU 402 may then execute instructions that the application is comprised of. In some cases, the CPU 402 may copy the application or portions of the application from memory accessed via the network connectivity devices 412 or via the I/O devices 410 to the RAM 408 or to memory space within the CPU 402, and the CPU 402 may then execute instructions that the application is comprised of. During execution, an application may load instructions into the CPU 402, for example load some of the instructions of the application into a cache of the CPU 402. In some contexts, an application that is executed may be said to configure the CPU 402 to do something, e.g., to configure the CPU 402 to perform the function or functions promoted by the subject application. When the CPU 402 is configured in this way by the application, the CPU 402 becomes a specific purpose computer or a specific purpose machine.

Secondary storage 404 may be used to store programs which are loaded into RAM 408 when such programs are selected for execution. The ROM 406 is used to store instructions and perhaps data which are read during program execution. ROM 406 is a non-volatile memory device which typically has a small memory capacity relative to the larger memory capacity of secondary storage 404. The secondary storage 404, the RAM 408, and/or the ROM 406 may be referred to in some contexts as computer readable storage media and/or non-transitory computer readable media. I/O devices 410 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 412 may take the form of modems, modem banks, Ethernet cards, universal serial bus (USB) interface cards, wireless local area network (WLAN) cards, radio transceiver cards, and/or other well-known network devices. The network connectivity devices 412 may provide wired communication links and/or wireless communication links. These network connectivity devices 412 may enable the processor 402 to communicate with the Internet or one or more intranets. With such a network connection, it is contemplated that the processor 402 might receive information from the network, or might output information to the network. Such information, which may include data or instructions to be executed using processor 402 for example, may be received from and outputted to the network, for example, in the form of a computer data baseband signal or signal embodied in a carrier wave.

The processor 402 executes instructions, codes, computer programs, scripts which it accesses from hard disk, floppy disk, optical disk, flash drive, ROM 406, RAM 408, or the network connectivity devices 412. While only one processor 402 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 404, for example, hard drives, floppy disks, optical disks, and/or other device, the ROM 406, and/or the RAM 408 may be referred to in some contexts as non-transitory instructions and/or non-transitory information.

In an embodiment, the computer system 400 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, the functionality disclosed above may be provided by executing the application and/or applications in a cloud computing environment. Cloud computing may comprise providing computing services via a network connection using dynamically scalable computing resources.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A vehicle identification system (VIS) for identifying one or more vehicles in a spatial domain, the system comprising:
a signal transmitter for transmitting an excitation signal to an address of a target vehicle of a plurality of vehicles present in the spatial domain;
a spatial detection system for providing positional information of the plurality of vehicles present in the spatial domain; and
a vehicle identification unit (VIU) in signal communication with the spatial detection system, the VIU comprising one or more processors and one or more storage devices coupled to the one or more processors, the one or more storage devices configured to store instructions that, when executed by the one or more processors, configure the one or more processors to:
(a) identify a positional signature in the positional information received from the spatial detection system; and
(b) correlate the address of the target vehicle with the positional signature to identify the target vehicle in the spatial domain.

2. The VIS of claim 1, wherein the excitation signal comprises a random signal.

3. The VIS of claim 1, wherein the excitation signal is superimposed onto a control input that is applied to the target vehicle.

4. The VIS of claim 1, wherein the target vehicle is configured to produce the positional signature in response to receiving the excitation signal.

5. The VIS of claim 1, wherein the plurality of vehicles correspond to a plurality of independent domains.

6. The VIS of claim 1, wherein the spatial domain comprises three-dimensional (3D) physical space.

7. The VIS of claim 1, wherein the spatial detection system comprises an active spatial detection system comprising a signal generator and a signal receiver configured to receive spatial signals generated by the signal generator and that have interacted with at least some of the plurality of vehicles.

8. The VIS of claim 7, wherein the spatial signals generated by the signal generator comprise electromagnetic energy.

9. The VIS of claim 1, wherein the spatial detection system comprises a passive spatial detection system.

10. The VIS of claim 1, wherein the spatial detection system is configured to collect at least one of electromagnetic energy or acoustic energy.

11. The VIS of claim 1, wherein:
the signal transmitter is configured to transmit a plurality of the excitation signals that are different from one another to a plurality of addresses of a plurality of target vehicles present in the spatial domain; and
the instructions, when executed by the one or more processors of the VIU, configure the one or more processors to:
(c) identify a plurality of positional signatures that are different from one another in the positional information received from the spatial detection system; and
(d) correlate the plurality of addresses of the target vehicles with the plurality of positional signatures to independently identify each of the plurality of target vehicles in the spatial domain.

12. A method for identifying one or more vehicles in a spatial domain, the method comprising:
(a) transmitting an excitation signal to an address of a target vehicle of a plurality of vehicles present in the spatial domain;
(b) receiving positional information from a spatial detection system associated with a plurality of vehicles present in a spatial domain;
(c) identifying a positional signature in the positional information received from the spatial detection system, the positional signature associated with the excitation signal; and
(d) correlating the address of the target vehicle with the positional signature to identify the target vehicle in the spatial domain.

13. The method of claim 12, wherein the excitation signal comprises a random signal.

14. The method of claim 12, further comprising:
(e) superimposing the excitation signal onto a control input applied to the target vehicle to cause the target vehicle to produce the positional signature.

15. The method of claim 12, further comprising:
(e) capturing by the spatial detection system at least one of electromagnetic energy or acoustic energy propagating through the spatial domain to determine the positional information.

16. The method of claim 12, further comprising:
(e) generating a spatial signal by the spatial detection system that propagates through the spatial domain; and
(f) capturing the spatial signal by the spatial detection system in response to the spatial signal interacting with at least one of the plurality of vehicles.

17. The method of claim 12, wherein the spatial domain comprises three-dimensional (3D) physical space.

18. A system, comprising:
one or more processors; and
one or more storage devices coupled to the one or more processors, the one or more storage devices configured to store instructions that, when executed by the one or more processors, configure the one or more processors to:
(a) receive positional information from a spatial detection system associated with a plurality of vehicles present in a spatial domain;
(b) identify a positional signature in the positional information received from the spatial detection system, the positional signature associated with an excitation signal transmitted to an address of a target vehicle of the plurality of vehicles; and
(c) correlate the address of the target vehicle with the positional signature to identify the target vehicle in the spatial domain.

19. The system of claim 18, wherein the excitation signal comprises a random signal.

20. The system of claim 18, wherein the excitation signal is superimposed onto a control input that is applied to the target vehicle.
